(19) United States
(12) Patent Application Publication
(10) Pub. No.: US 2025/0373671 A1
(43) Pub. Date: Dec. 4, 2025

(54) SHORT MESSAGE SERVICE (SMS) OVER NON-ACCESS STATUM (NAS) FALLBACK IN WIRELESS COMMUNICATION NETWORK

(71) Applicant: T-MOBILE INNOVATIONS LLC, Overland Park, KS (US)

(72) Inventors: Harikishore Allu Balan, Lynnwood, WA (US); Jagannadha Anudeep Varma Datla, Kent, WA (US)

(21) Appl. No.: 18/675,968

(22) Filed: May 28, 2024

(51) Int. Cl. H04L 65/1016; H04L 65/1073; H04W 4/14

(52) U.S. Cl. CPC H04L 65/1016; H04L 65/1073; H04W 4/14

(57) ABSTRACT

Various embodiments include a wireless communication network that comprises a control plane and a user plane. The user plane supports a multimedia bearer for a wireless user device. In response to multimedia bearer failure for the user device, the control plane registers the wireless user device for control plane messaging. The control plane exchanges text messages with the user device over a signaling link of the control plane. In response to establishment of the multimedia bearer for the wireless user device, the control plane deregisters the wireless user device for control plane messaging. The control plane directs the wireless user device to register with a multimedia system for service over the multimedia bearer.

### TECHNICAL FIELD

Various embodiments of the present technology relate to messaging, and more specifically, to maintaining messaging capability for a wireless user device in response to bearer setup failure.

### BACKGROUND

Wireless communication networks provide wireless data services to wireless user devices. Exemplary wireless data services include voice calling, video calling, internet-access, media-streaming, online gaming, social-networking, and machine-control. Exemplary wireless user devices comprise phones, computers, vehicles, robots, and sensors. Radio Access Networks (RANs) exchange wireless signals with the wireless user devices over radio frequency bands. The wireless signals use wireless network protocols like Fifth Generation New Radio (5GNR), Long Term Evolution (LTE), Institute of Electrical and Electronic Engineers (IEEE) 802.11 (WIFI), and Low-Power Wide Area Network (LP-WAN). The RANs exchange network signaling and user data with network elements that are often clustered together into wireless network cores over backhaul data links. The core networks execute network functions to provide wireless data services to the wireless user devices.

When a user device attaches to a wireless communication network over a RAN, the device transfers a registration request to a control plane network function. The control plane network function establishes a control signaling link with the device over the RAN. This signaling link is referred to as a Non-Access Statum (NAS) link. Registration entails authenticating the identity of the user device and authorizing the device for service on the network. The control signaling link carries registration related information between the control plane and the user device. Once the device is authenticated and authorized, the control plane network function interfaces with a core network user plane to setup a default bearer over the RAN. The default bearer is a signaling link that carrier user data for voice sessions, video sessions, IP (Internet Protocol) messaging sessions, and IP data sessions (e.g., media streaming). However, network errors like IP address allocation failure and server timeout may occur that cause default bearer failure. In response to default bearer failure, the control plane network function notifies the user device. The device must then reregister with the network to reattempt establishing the default bearer. During the period of time the default bearer is down, voice sessions, video sessions, IP messaging sessions, and IP data sessions for the device are inhibited.

Unfortunately, in some instances, wireless communication networks may not effectively or efficiently maintain communication links for wireless user devices in response to default bearer failure.

### OVERVIEW

This Overview is provided to introduce a selection of concepts in a simplified form that are further described below in the Technical Description. This summary is not intended to identify key features or essential features of the claimed subject matter, nor is it intended to be used as an aid in determining the scope of the claimed subject matter.

Various embodiments of the present technology relate to solutions for messaging. Some embodiments comprise a method. The method comprises registering, by a control plane of a wireless communication network, the wireless user device for control plane messaging in response to a multimedia bearer failure for a wireless user device. The method further comprises exchanging, by the control plane, text messages with the user device over a signaling link of the control plane. The method further comprises deregistering, by the control plane, the wireless user device for control plane messaging in response to establishment of a multimedia bearer for the wireless user device. The method further comprises directing, by the control plane, the wireless user device to register with a multimedia system for service over the multimedia bearer.

Some embodiments comprise a wireless communication network. The wireless communication network comprises a control plane and a user plane. The user plane supports a multimedia bearer for a wireless user device. The control plane registers the wireless user device for control plane messaging in response to a multimedia bearer failure for the wireless user device. The control plane exchanges text messages with the user device over a signaling link of the control plane. The control plane deregisters the wireless user device for control plane messaging in response to establishment of the multimedia bearer for the wireless user device. The control plane directs the wireless user device to register with a multimedia system for service over the multimedia bearer.

Some embodiments comprise one of more non-transitory computer readable storage media having program instructions stored thereon. When executed by a computing system, the program instructions direct the computing system to perform operations. The operations comprise receiving, during initial registration, a failure notification that indicates a default bearer setup failure for a wireless user device. The operations further comprise registering the wireless user device with a Short-Message-Service Center (SMSC) in response to the default bearer setup failure. The operations further comprise exchanging Short-Message-Service (SMS) messages for the user device with the SMSC. The operations further comprise exchanging the SMS messages with the user device of a Non-Access Stratum (NAS) link. The operations further comprise receiving a success notification that indicates a default bearer setup success for the wireless user device subsequent to receiving a retry request from the wireless user device. The operations further comprise deregistering the wireless user device with the SMSC in response to the default bearer setup success. The operations further comprise notifying the wireless user device of the default bearer setup success. The operations further comprise directing the wireless user device to use the default bearer for messaging.

### DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a communication network.

FIG. 2 illustrates a first exemplary operation of the communication network.

FIG. 3 illustrates a second exemplary operation of the communication network.

FIG. 4 illustrates a third exemplary operation of the communication network.

FIG. 5 illustrates a Fifth Generation (5G) communication network.

FIG. 6 illustrates a User Equipment (UE) in the 5G communication network.

FIG. 7 illustrates a 5G Radio Access Network in the 5G communication network.

FIG. 8 illustrates a non-Third Generation Partnership Project (non-3GPP) Access Node (AN) in the 5G communication network.

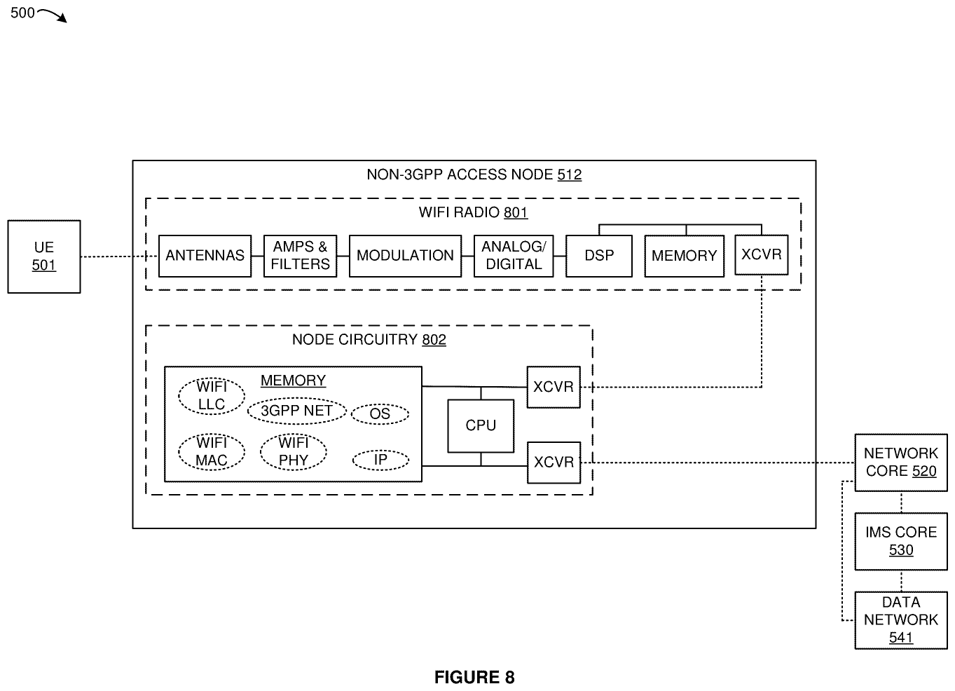

FIG. 9 illustrates a Network Function Virtualization Infrastructure (NFVI) in the 5G communication network.

FIG. 10 further illustrates the NFVI in the 5G communication network.

FIG. 11 illustrates an exemplary operation of the 5G communication network.

FIG. 12 illustrates an exemplary Long Term Evolution (LTE) communication network.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### TECHNICAL DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

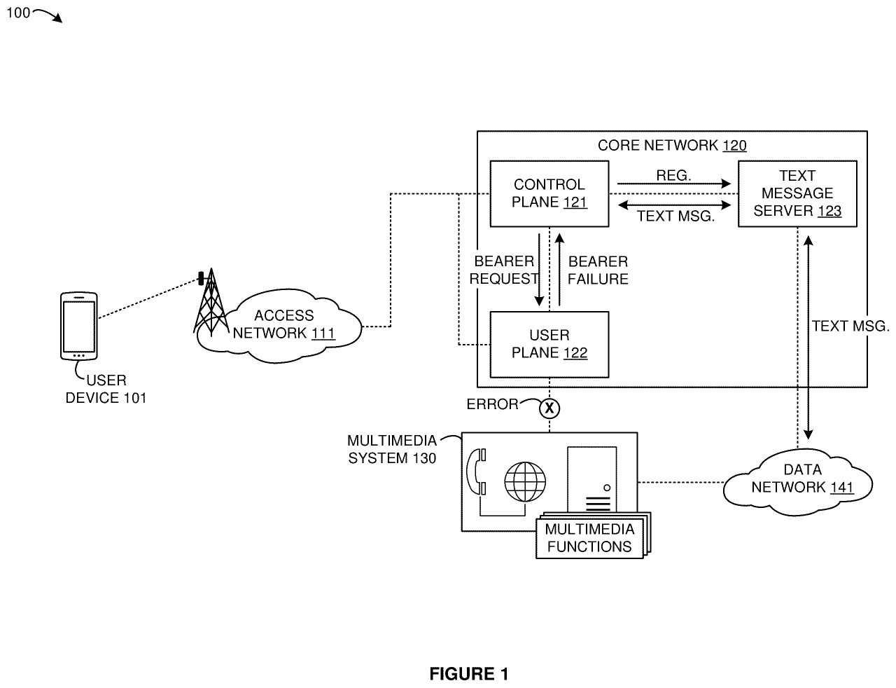

FIG. 1 illustrates communication network 100 to maintain messaging capability for a wireless user device in response to bearer setup failure. Communication network 100 provides services like media-streaming, internet-access, voice/video calling, text messaging, machine communications, or some other wireless communications product. Communication network 100 comprises user device 101, access network 111, core network 120, multimedia core 130, and data network 141. Core network 120 comprises control plane 121, user plane 122, and text message server 123. In other examples, communication network 100 may comprise additional or different elements than those illustrated in FIG. 1.

Various examples of network operation and configuration are described herein. In some examples, user device 101 attaches to core network 120 over access network 111. Device 101 registers with control plane 121 for service on network 100. Control plane 121 authenticates and authorizes device 101 for wireless service on network 100. Control plane 121 directs user plane 122 to establish a multimedia bearer for user device 101. The multimedia bearer carries IP packets for voice, video, and text sessions between user device 101 and multimedia core 130 and over access network 111 and user plane 122. However, an error occurs preventing the establishment of the multimedia bearer. For example, user plane 122 may fail to respond to the request (e.g., timeout) or multimedia system 130 may fail to interact with user plane 122 to set up the bearer (e.g., Internet Protocol (IP) address allocation failure). Control plane 121 detects the multimedia bearer failure (e.g., based on non-responsiveness of user plane 122 or via a notification from user plane 122). It should be appreciated that when device 101 lacks a multimedia bearer, device 101 is inhibited from sending/receiving text messages, voice calls, video calls, and data. As such, control plane 121 responsively decides to register device 101 for control plane text messaging in response to the multimedia bearer failure to maintain a communication link for device 101. For example, control plane 121 fallback device 101 to Short-Message-Service (SMS) of Non-Access Statum (NAS) messaging in response to default bearer failure. Text message server 123 receives text messages (e.g., SMS messages) for device 101 from data network 141. Control plane 121 exchanges text messages with server 123. Control plane 121 exchanges text messages with user device 101 over a control plane link that traverses access network 111. For example, control plane 121 may exchange SMS messages with user device 101 over a Non-Access Stratum (NAS) link.

Subsequently, control plane 121 detects the establishment of the multimedia bearer for device 101. For example, control plane 121 may transfer a retry request to user plane 122 to setup the multimedia bearer and user plane 122 may successfully setup the bearer after the initial failure. Control plane 121 deregisters user device 101 with server 123 and notifies device 101 of the successful bearer establishment. User device 101 registers with multimedia system 130 for communications (e.g., Internet Protocol (IP) based communications) over the multimedia bearer. Multimedia system 130 receives messages for user device 101 from data network 141. Multimedia system 130 exchanges the messages with user device 101 over the multimedia bearer that traverses user plane 122 and access network 111.

Advantageously, wireless communication network 100 effectively maintains communication links for wireless user device 100 in response to default bearer failure. Moreover, network 100 efficiently exchanges text messages with device 100 over a control plane signaling link during default bearer failure.

User device 101 comprises a vehicle, drone, robot, computer, phone, sensor, or another type of data appliance with wireless and/or wireline communication circuitry. User device 101 and access network 111 communicate over links using wireless/wireline technologies like Sixth Generation Radio (6GR), Fifth Generation New Radio (5GNR), Long Term Evolution (LTE), Institute of Electrical and Electronic Engineers (IEEE) 802.11 (WIFI), Low-Power Wide Area Network (LP-WAN), Bluetooth, and/or some other type of wireless networking protocol. The wireless technologies use electromagnetic frequencies in the low-band, mid-band, high-band, or some other portion of the electromagnetic spectrum. The wired connections comprise metallic links, glass fibers, and/or some other type of wired interface.

Although access network 111 is illustrated as a tower, network 111 may comprise another type of mounting structure (e.g., a building), or no mounting structure at all. Access network 111 comprises a Sixth Generation (6G) Radio Access Network (RAN), Fifth Generation (5G) RAN, LTE RAN, gNodeB, eNodeB, NB-IoT access node, trusted non-3GPP access node, untrusted non-3GPP access node, LP-WAN base station, wireless relay, WIFI hotspot, Bluetooth access node, and/or another wireless or wireline network transceiver. Access network 111 exchanges network signaling and user data with control plane 121 and user plane 122 clustered together into core network 120. Access network 111 is connected to network core 120 over backhaul data links. Access network 111 and core network 120 may communicate via edge networks like internet backbone providers, edge computing systems, or another type of edge system to provide the backhaul data links between node 111 and core network 120.

Access network 111 may comprise Radio Units (RUs), Distributed Units (DUs) and Centralized Units (CUs). The RUs may be mounted at elevation and have antennas, modulators, signal processors, and the like. The RUs are connected to the DUs which are usually nearby network computers. The DUs handle lower wireless network layers like the Physical Layer (PHY), Media Access Control (MAC), and Radio Link Control (RLC). The DUs are connected to the CUs which are larger computer centers that are closer to the network cores. The CUS handle higher wireless network layers like the Radio Resource Control (RRC), Service Data Adaption Protocol (SDAP), and Packet Data Convergence Protocol (PDCP). The CUs are coupled to network functions in core network 120. Access network 111 may also comprise Baseband Units (BBUs). The BBUs handle lower and higher network layers like RRC, PDCP, RLC, MAC, and PHY. The BBUs are coupled to network entities in core 120.

Core network 120 is representative of computing systems that provide wireless data services to user device 101 over access network 111. Exemplary computing systems comprise Network Function Virtualization Infrastructure (NFVI) systems, data centers, server farms, cloud computing networks, hybrid cloud networks, and the like. Core network 120 may comprise a Third Generation Partnership Project (3GPP) core network architecture like Sixth Generation Core (6GC), Fifth Generation Core (5GC), Evolved Packet Core (EPC), and/or another type of 3GPP core network architecture. Access network 111, core network 120, multimedia system 130, and data network 141 communicate over various links that use metallic links, glass fibers, radio channels, or some other communication media. The links use 6GC, 5GC, EPC, IEEE 802.3 (ENET), Time Division Multiplex (TDM), Data Over Cable System Interface Specification (DOCSIS), Internet Protocol (IP), General Packet Radio Service Transfer Protocol (GTP), 6GR, 5GNR, LTE, WIFI, virtual switching, inter-processor communication, bus interfaces, and/or some other data communication protocols. The computing systems of core network 120 store and execute the network functions/entities to form control plane 121, user plane 122, and text message server 123. Control plane 121 may comprise network functions/entities like Access and Mobility Management Function (AMF), Session Management Function (SMF), Policy Control Function (PCF), Unified Data Management (UDM), Mobility Management Entity (MME), and Home Subcriber Server (HSS). User plane 122 comprises network functions/entities like User Plane Function (UPF), Serving Gateway (S-GW), Packet Gateway (P-GW). Text message server 123 comprises network functions/entities like Short Message Service Center (SMSC) and the like. Data network 141 comprises an Application Server (AS) that hosts applications (e.g., media streaming applications, SMS applications, etc.) for device 101.

Multimedia system 131 is representative of computing systems that provide wireless multimedia services (e.g., IP based voice/video calling, text messaging, etc.) to user device 101. Exemplary computing systems comprise Internet Protocol Multimedia Subsystem (IMS), Network Function Virtualization Infrastructure (NFVI) systems, data centers, server farms, cloud computing networks, hybrid cloud networks, and the like. The computing systems of multimedia system 131 store and execute multimedia functions to provide services like voice calling, video conferencing, and text messaging to user devices 101. Exemplary multimedia functions include Call Session Control Function (CSCF), Telephony Application Server (TAS), and Rich communication Service (RCS) AS, SMS AS, and the like.

User device 101 and access network 111 comprise antennas, amplifiers, filters, modulation, analog/digital interfaces, microprocessors, software, memories, transceivers, bus circuitry, and the like. User device 101, access network 111, core network 120, multimedia core 130, and data network 141 comprise microprocessors, software, memories, transceivers, bus circuitry, and the like. The microprocessors comprise Digital Signal Processors (DSP), Central Processing Units (CPU), Graphical Processing Units (GPU), Application-Specific Integrated Circuits (ASIC), Field Programmable Gate Array (FPGA), and/or the like. The memories comprise Random Access Memory (RAM), flash circuitry, disk drives, and/or the like. The memories store software like operating systems, user applications, radio applications, and network functions. The microprocessors retrieve the software from the memories and execute the software to drive the operation of wireless communication network 100 as described herein.

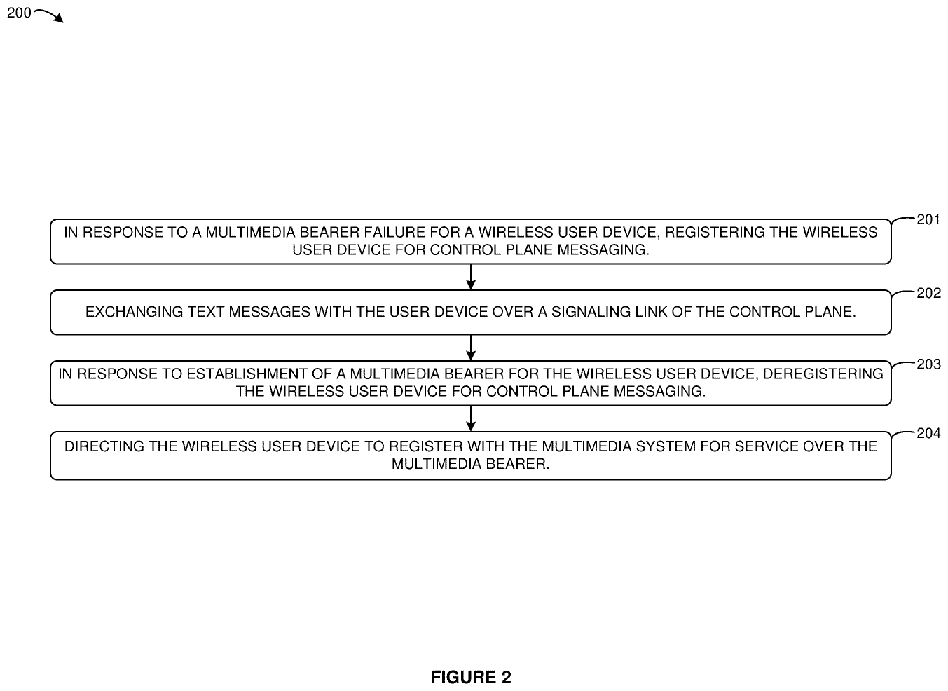

FIG. 2 illustrates process 200. Process 200 comprises an exemplary operation of communication network 100 to maintain messaging capability for a wireless user device in response to bearer setup failure. The operation may vary in other examples. The operations of process 200 comprise, in response to a multimedia bearer failure for a wireless user device, registering the wireless user device for control plane messaging (step 201). The operations further comprise exchanging text messages with the user device over a signaling link of the control plane (step 202). The operations further comprise, in response to establishment of a multimedia bearer for the wireless user device, deregistering the wireless user device for control plane messaging (step 203). The operations further comprise directing the wireless user device to register with a multimedia system for service over the multimedia bearer (step 204).

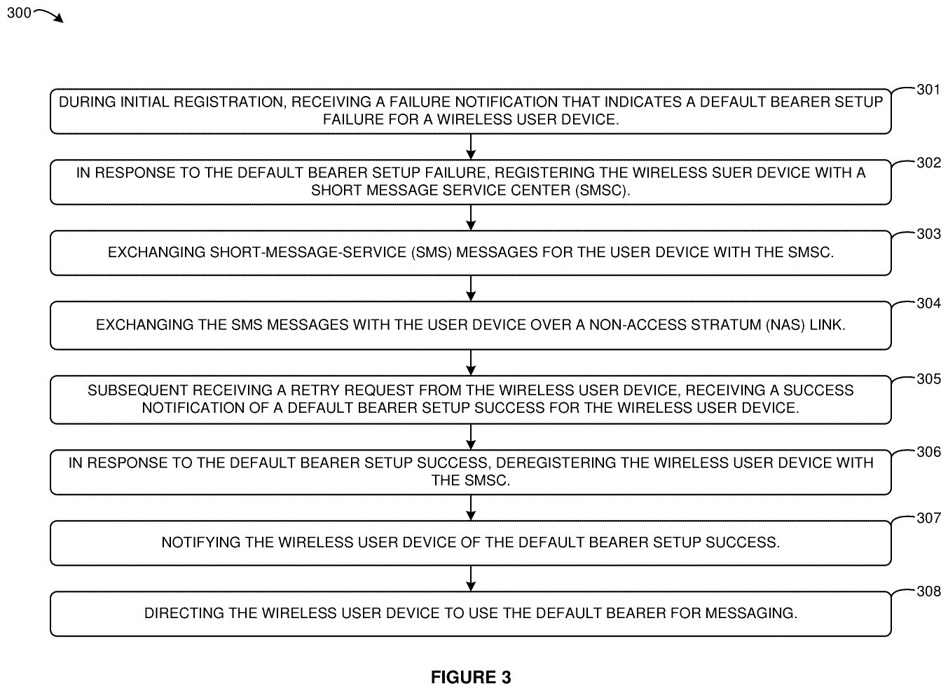

FIG. 3 illustrates process 300. Process 300 comprises an exemplary operation of communication network 100 to maintain messaging capability for a wireless user device in response to bearer setup failure. Process 300 comprises an example of process 200 illustrated in FIG. 2, however process 200 may differ. The operation may vary in other examples. The operations of process 300 comprise, during initial registration, receiving a failure notification that indicates a default bearer setup failure for a wireless user device (step 301). The operations further comprise, in response to the default bearer setup failure, registering the wireless user device with an SMSC (step 302). The operations further comprise exchanging SMS messages for the user device with the SMSC (step 303). The operations further comprise exchanging the SMS messages with the user device of a NAS link (step 304). The operations further comprise, subsequent to receiving a retry request from the wireless user device, receiving a success notification that indicates a default bearer setup success for the wireless user device (step 305). The operations further comprise, in response to the default bearer setup success, deregistering the wireless user device with the SMSC (step 306). The operations further comprise notifying the wireless user device of the default bearer setup success (step 307). The operations further comprise directing the wireless user device to use the default bearer for messaging (step 308).

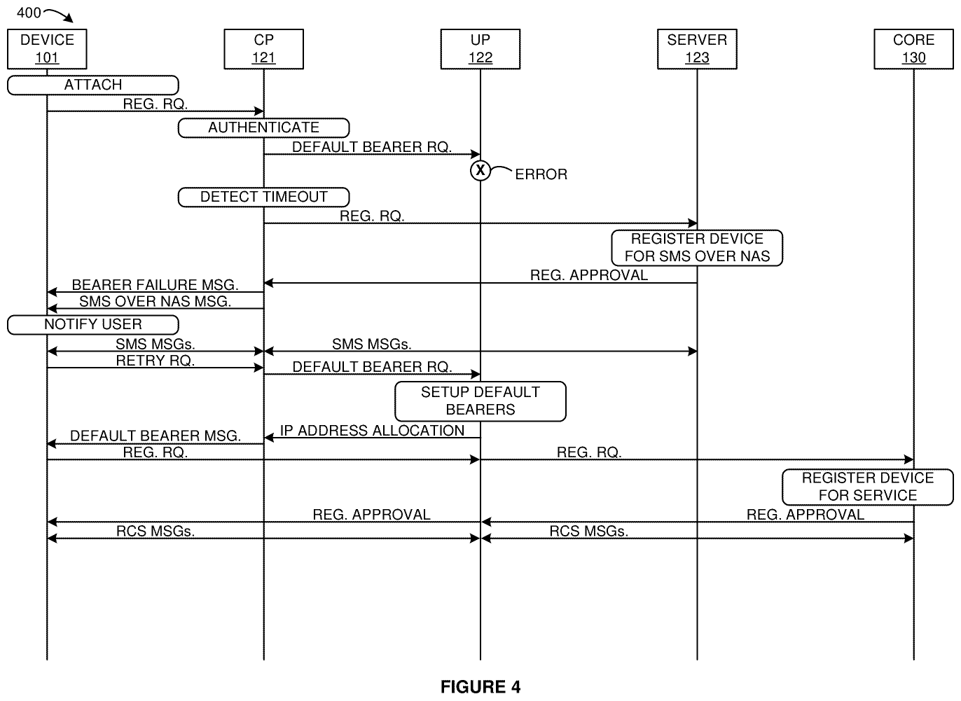

FIG. 4 illustrates process 400. Process 400 comprises an exemplary operation of wireless communication network 100 to maintain messaging capability for a wireless user device in response to bearer setup failure. Process 400 comprises an example of process 200 illustrated in FIG. 2 and process 300 illustrated in FIG. 3, however processes 200 and 300 may differ. The operation may vary in other examples. In some examples, device 101 attaches to access network 101. Device 101 and access network 111 implement a Random Access Channel (RACH) process to establish a default signaling link for device 101. Once the signaling link is established, device 101 transfers a NAS registration request to control plane (CP) 121 over access network 111 via the default signaling link. The registration request includes information like a registration type, 5G-Globally Unique Temporary Identifier (5G-GUTI), Tracking Area ID (TAI), Network Slice Selection Assistance Information (NSSAI) requests, UE capabilities, Protocol Data Unit (PDU) session requests, and the like.

Control plane 121 authenticates the identity of device 101 and authorizes device 101 for service on network 100 based on the registration request. For example, control plane 121 may access a subscriber profile for device 101 managed by a UDM to authenticate and authorize device 101. In response to authentication and authorization, control plane 121 transfers a default bearer request to user plane (UP) 122. The requested default bearer travers access network 111 and user plane 122 to carry IP voice/video/text packets between device 101 and multimedia core 130 and to carry user data packets between device 101 and data network 141. An error occurs and user plane 122 fails to acknowledge the request. The request times out and control plane 121 decides to register device 101 with server 123 to maintain a communication link for device 101. Control plane 121 detects SMS over NAS messaging fallback conditions for device 101 and transfers a registration request for device 101 to text messaging server 123. Server 123 registers device 101 for SMS over NAS and transfers a registration approval message to control plane 121.

Once registered for SMS over NAS, control plane 121 registers device 101 for service on network 100 and transfers a registration approval message to device 101. The registration approval message indicates the default bearer failure over a NAS signaling link between device 101 and control plane 121 and that SMS over NAS is enabled for device 101. The approval message directs device 101 to reattempt to establish the default bearer (e.g., based on a timer). Device 101 presents a notification for the user indicating device 101 is in an SMS over NAS mode. Server 123 receives SMS messages for device 101 from data network 141 and delivers the SMS messages to control plane 121. Control plane 121 transfers the SMS messages to device 101 over the NAS signaling link that traverses access network 101. Device 101 generates SMS messages for other devices outside of network 100. Device 101 transfers the SMS messages to control plane 121 over the NAS link. Control plane 121 forwards the SMS messages to server 123 which in turn forwards the SMS messages to data network 141.

Device 101 transfers a retry request (e.g., in response to a retry timer expiration) to control plane 121 to create a default bearer. Since device 101 is registered on network 100, control 121 forgoes authentication/authorization of device 101 and transfers a default bearer request to user plane 122. User plane 122 is responsive and establishes the default bearer. User plane 122 interfaces with multimedia core 130 to allocate an IP address for device 101 on the bearer. User plane 122 indicates that the default bearer has been established and the IP address to control plane 121. Control plane 121 interfaces with server 123 to deregister device 101 for SMS over NAS communications. Control plane 121 notifies device 101 that the bearer has been setup and directs device to register with multimedia core 130 to receive IP based communication service over the default bearer. For example, control plane 121 may transfer an RRC reconfiguration message that includes primary and secondary cell IDs as well as radio bearer configurations that define the default bearer.

In response to default bearer creation, device 101 transfers a multimedia registration request to core 130 over user plane 122. For example, when core 130 comprises an IMS, device 101 may transfer a Session Initiation Protocol (SIP) message that encapsulates an IMS registration request to core 130. Multimedia core 130 registers device for multimedia services like voice/video calling, RCS messaging, and the like. Core 130 transfers a registration approval message to device 101 over user plane 122. Device 101 exchanges RCS (e.g., IP based messages) with core 130 over the default bearer that traverses access network 111 and user plane 122. Core 130 exchanges the RCS messages with data network 141.

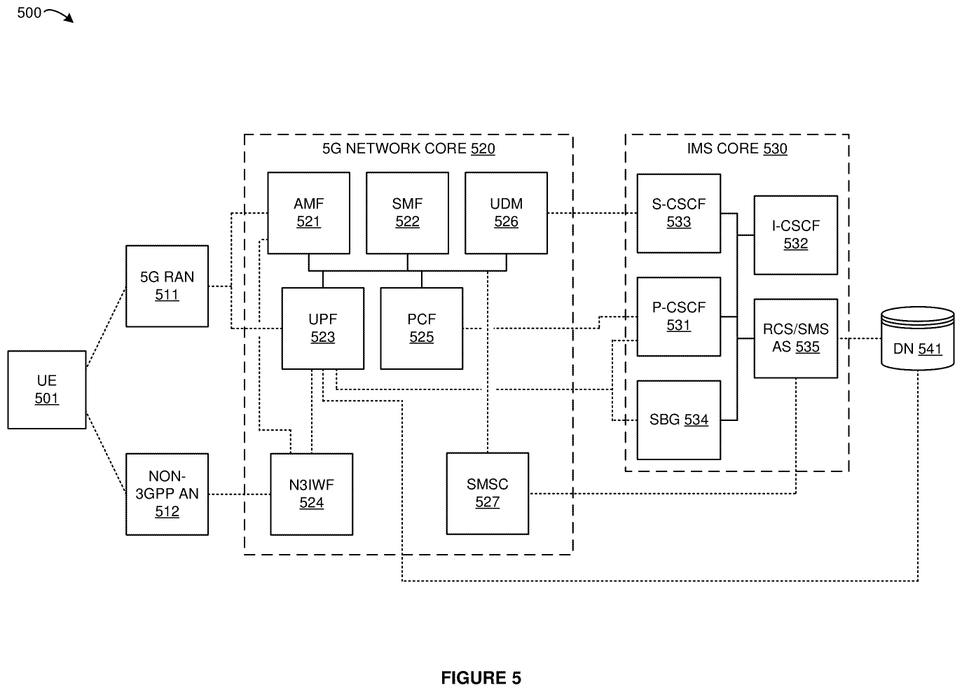

FIG. 5 illustrates 5G communication network 500 to maintain SMS messaging capability for a wireless user device in response to default bearer setup failure during initial registration. 5G communication network 500 comprises an example of communication network 100 illustrated in FIG. 1, however network 100 may differ. 5G communication network 500 comprises User Equipment (UE) 501, 5G RAN 511, non-3GPP access node 512, 5G network core 520, IMS core 530, and data network (DN) 541. 5G network core 520 comprises AMF 521, SMF 522, UPF 523, non-3GPP Interworking Function (N3IWF) 524, PCF 525, UDM 526, and SMSC 527. Other network functions and network entities like Authenticating Server Function (AUSF), Network Slice Selection Function (NSSF), Unified Data Registry (UDR), Home Subscriber Register (HLR), Network Repository Function (NRF), Short Message Service Function (SMSF), Network Exposure Function (NEF), Application Function (AF), Equipment Identity Register (EIR), and Session Communication Proxy (SCP) are typically present in 5G network core 520 but are omitted for clarity. IMS core 530 comprises Proxy-Call Session Control Function (P-CSCF) 531, Interrogating-Call Session Control Function (I-CSCF) 532, Serving-Call Session Control Function (S-CSCF) 533, Session Border Controller (SBG) 534, and RCS/SMS AS 535. Other network functions and network entities like Telephony Application Service (TAS), Interconnect Session Border Controller (ISBC), and SMSC AS are typically present in IMS core 530 but are omitted for clarity. In other examples, 5G communication network 500 may comprise different or additional elements than those illustrated in FIG. 5.

In some examples, UE 501 wirelessly attaches to 5G RAN 511 over a 5GNR link. UE 501 may also (or instead) attach to non-3GPP access node 512 over a non-3GPP (e.g., Wifi) link. UE 501 undergoes a RACH procedure with 5G RAN 511 to establish a secure signaling channel. UE 501 transfers a registration request to AMF 521 over 5G RAN 511. The registration request indicates a registration type, 5G-GUTI, TAI, NSSAI requests, UE capabilities, PDU session requests, and the like. In response to the registration request, AMF 521 transfers a NAS identity request to UE 501 over a NAS signaling link between UE 501 and AMF 521 that traverses RAN 511. UE 501 indicates its Subscriber Concealed Identifier (SUCI) to AMF 521 over the NAS link that traverses 5G RAN 511. AMF 521 indicates the SUCI of UE 501 to UDM 526, typically over an AUSF, to retrieve authentication vectors to authenticate UE 501. UDM 526 returns the Subscriber Permanent Identifier (SUPI) for UE 501 and authentication vectors like an expected result, random number, key selection criteria, and the like. AMF 521 transfers an authentication challenge that comprises the random number and key selection criteria to UE 501 over the NAS link that traverses RAN 511. UE 501 hashes random number with its secret key to generate an authentication result and indicates the authentication result to AMF 521 over the NAS link. AMF 521 matches the expected result retrieved from UDM 526 with the authentication result received from UE 501 to authenticate UE 501.

Responsive to the authentication, AMF 521 transfers a context registration request to UDM 526 that includes AMF ID, a supported feature list, a Permanent Equipment Identifier (PEI) for UE 501, and the like. UDM 526 indicates successful UDM registration to AMF 521. In response, AMF 521 requests access and mobility subscription data, SMS selection subscription data, and UE context in SMF data from UDM 526. UDM 526 accesses the subscriber profile for UE 501 and returns the requested data. The access and mobility subscription data comprises a supported feature list for UE 501 (e.g., Quality of Service Class Indicator (QCI), Aggregate Maximum Bit Rate (AMBR), latency, voice/video calling, internet access, etc.), a General Public Subscription Identifier (GPSI) array, slice selection information, and the like. The SMF selection data comprises a supported feature list, and a list of S-NSSAIs and associated information. The UE context in SMF data comprises PDU session and EPC interworking information. AMF 521 forms the UE context for UE 501 using the retrieved information. The UE context defines the authorized services for UE 501.

AMF 521 transfers a policy creation request to PCF 525 to create a policy association for UE 501. PCF 525 responds to the request with policy association information like the SUPI, GPSI, PEI, and user location information for UE 501. PCF 525 subscribes to AMF 521 for event reporting like user location updates, registration state changes, communication failure events, and the like. AMF 521 creates a PCF subscription based on the policy association information and signals to PCF 525 of the successful subscription creation.

Responsive to policy association creation, AMF 521 selects SMF 522 to serve UE 501 based on SMF selection data received from UDM 526 and network policies received from PCF 525. AMF 521 may also select one or more network slices for UE 501 based on the slice selection information. AMF 521 transfers a PDU session list (as received during the registration request) and PDU session activation command. In normal operations, SMF 522 allocates UE IP addresses for the requested PDU sessions, allocates Tunnel End Point ID (TEID) for the session, and selects UPF 523 to support the PDU sessions. Upon selection of UPF 523, SMF 522 transfers a session modification request that includes a session endpoint identifier and TEID to UPF 523 to setup the default bearer for UE 501. The default bearer is a link to carry data and voice/IP message packets between UE 501 and data network 541. The default bearer traverses 5G RAN 511 (and/or non-3GPP access node 512), UPF 523, and IMS core 530. Upon reception of the request, UPF 523 may begin receiving and buffering downlink data for the PDU sessions of UE 501.

However, an error occurs in SMF 522 and/or UPF 523 that prevents the establishment of the default bearer during the initial registration of UE 501. The error may comprise an IP allocation failure, a network timeout, or some other type of network error. For example, when the error comprises an IP allocation failure, an error may occur in the SMF 522 that prevents SMF 522 from allocating an IP address to UE 501. For example, when the error comprises a network timeout, UPF 523 may be non-responsive and the connection between SMF 522 and UPF 523 may timeout. Since the default bearer for UE 501 is not established, UE 501 is unable to exchange user data with data network 541 (e.g., internet traffic, media streaming, etc.) and is unable to exchange IP data (e.g., voice/video calls, RCS messages, etc.) with IMS core 530.

SMF 522 notifies AMF 521 of the default bearer establishment failure. In response, AMF 521 transfers an SMS over NAS registration request to SMSC 527 to create a communication link for UE 501 to support SMS over NAS. The link allows network 600 to provide SMS services to UE 501 when default bearer setup fails. SMSC 527 receives the request and retrieves SMS over NAS context for UE 501 from UDM 526. UDM 526 accesses UE 501′s subscriber profile and returns an SMS messaging Access Point Name (APN) or SMS messaging Data Network Name (DNN) for UE 501. SMSC 527 registers UE 501 for SMS over NAS service and transfers a SMS over NAS registration approval message to AMF 521. The approval message includes data like the messaging APN, messaging DNN, and/or other routing information to exchange SMS messages to/from UE 501 over the NAS link.

AMF 521 generates a registration failure message that indicates the default bearer creation failure and that SMS over NAS is enabled for UE 501. AMF 521 transfers the message to UE 501 over the NAS link that traverses 5G RAN 511. UE 501 notifies the user of the registration failure (e.g., data/voice service not available notification) and that SMS services are available. UE 501 generates/receives SMS messages and exchanges the messages with AMF 521 over the NAS link. AMF 521 exchanges the SMS messages with SMSC 527. SMCS 527 routes the SMS messages to/from data network 541 over RCS/SMS AS 535 in IMS core 530.

UE 501 generates and transfers a retry request to AMF 521 over the NAS link to attempt to establish the default bearer. UE 501 may rely on a retry timer or schedule provided by AMF 521 to govern when to send retry requests. In response, AMF 521 transfers another PDU session list and PDU session activation command to SMF 522. At this point, the IP allocation error or network timeout error is resolved on SMF 522/UPF 523. SMF 522 successfully allocates UE IP addresses for the requested PDU sessions, allocates a TEID, and selects UPF 523 to support the PDU sessions. Upon selection of UPF 523, SMF 522 transfers a session modification request that includes a session endpoint identifier and TEID to UPF 523 to setup the default bearer for UE 501. UPF 523 sets up a default bearer between UE 501, IMS core 530, and data network 541. UPF 523 begins receiving and buffering downlink data for the PDU sessions of UE 501 from data network 541.

SMF 522 notifies AMF 521 that the default bearer is set up as well as a network address for P-CSCF 531 for UE 501 to perform IMS registration. AMF 521 successfully registers UE 501 for service on network 500. AMF 521 generates a registration accept message that includes the UE context, allocated IP addresses for UE 501, and network address for P-CSCF 531. AMF 521 transfers a deregistration message to SMSC 527 to terminate SMS over NAS for UE 501. SMSC 527 deregisters UE 501 for SMS over NAS. AMF 521 transfers the registration accept message to UE 501 over the NAS link that traverses RAN 511. The message directs UE 501 to end SMS over NAS and to switch to IP messaging over the default bearer.

UE 501 generates an IMS registration request to register with IMS core 530 based on the UE context. UE 501 uses the network address for P-CSCF 531 in the UE context to transfer the IMS registration request to UPF 523 over the default bearer that traverses RAN 511. UPF 523 identifies the network address for P-CSCF 631 in the registration request and forwards the request to P-CSCF 531. P-CSCF 531 registers an IP address for UE 501 and retrieves a network address for I-CSCF 532 (e.g., by DNS query). P-CSCF 531 forwards the registration request to I-CSCF 532 using the retrieved network address. I-CSCF 532 interfaces with UDM 526 to identify available S-CSCFs. UDM 526 transfers the network address for S-CSCF 533 to I-CSCF. I-CSCF 532 forwards the registration request with the network address to S-CSCF 533. S-CSCF 533 receives the registration request and retrieves user authentication data associated with UE 501 from UDM 526. The authentication data typically includes a random number, an authentication token, a signed result, a cipher key, and an integrity key. S-CSCF 533 uses the authentication data to verify the identity of UE 501 and register UE 501 for IMS service. P-CSCF 531 indicates the successful IMS registration to UE 501 over the default bearer.

In response, UE 501 initiates a MO RCS session with another UE over IMS core 530. UE 501 generates a SIP invite message and addresses the message for delivery to P-CSCF 531. The SIP invite message includes the phone number for the other UE. UE 501 transfers the SIP invite to P-CSCF 531 over the default bearer that traverses RAN 511, UPF 523, and SBG 534. P-CSCF 531 interfaces with I-CSCF 532 and S-CSCF 533 to deliver the SIP invite to the called UE. S-CSCF 533 translates the phone number for the called UE into the IP address of the called UE. S-CSCF 533 forwards the SIP invite to the called UE (e.g., over data network 541). The called UE receives and accepts the SIP invite. P-CSCF 531 notifies S-CSCF 533 of the acceptance. S-CSCF 533 interfaces with RCS AS 535 to organize and control the end-to-end Realtime Transport Protocol (RTP) connection between UE 501 and the called UE. Once the RTP link is set up, the RCS session may begin. UE 501 exchanges user data for the MO RCS session with data network 541 over the default bearer that traverses RAN 511 and UPF 523. S-CSCF 533 interfaces with one or more of P-CSCF 531, I-CSFC 632, and RCS AS 535 to monitor the RCS session and control the data flow between UE 501 and data network 541.

In some examples, UE 501 instead (or additionally) attaches to network core 520 over non-3GPP access node 512. For example, UE 501 may be out of the coverage range of RAN 511 or UE 501 may attach to access node 512 based on user preference. Exemplary non-3GPP nodes include Wifi access nodes, Bluetooth access nodes, and the like. When using node 512, AMF 521 establishes a NAS link and default bearer to UE 501 that traverses N3IWF 524 and non-3GPP access node 512 during the registration process. The registration process over non-3GPP nodes is similar to the registration process over 3GPP nodes (e.g., RAN 511). When default bearer setup fails, AMF 521 may perform an SMS over NAS fallback for UE 501 using the NAS link that traverses N3IWF 524 and non-3GPP access node 512 as described above for communications over 5G RAN 511. In some examples, UE 501 may establish concurrent connections with network core 520 over both 5G RAN 511 and non-3GPP access node 512. When a RAN issue (e.g., RAN overload) impacts UE 501's connection with RAN 511 and default bearer failure occurs for UE 501's over non-3GPP access node 512, AMF 521 may perform SMS over NAS fallback for UE 501 over node 512.

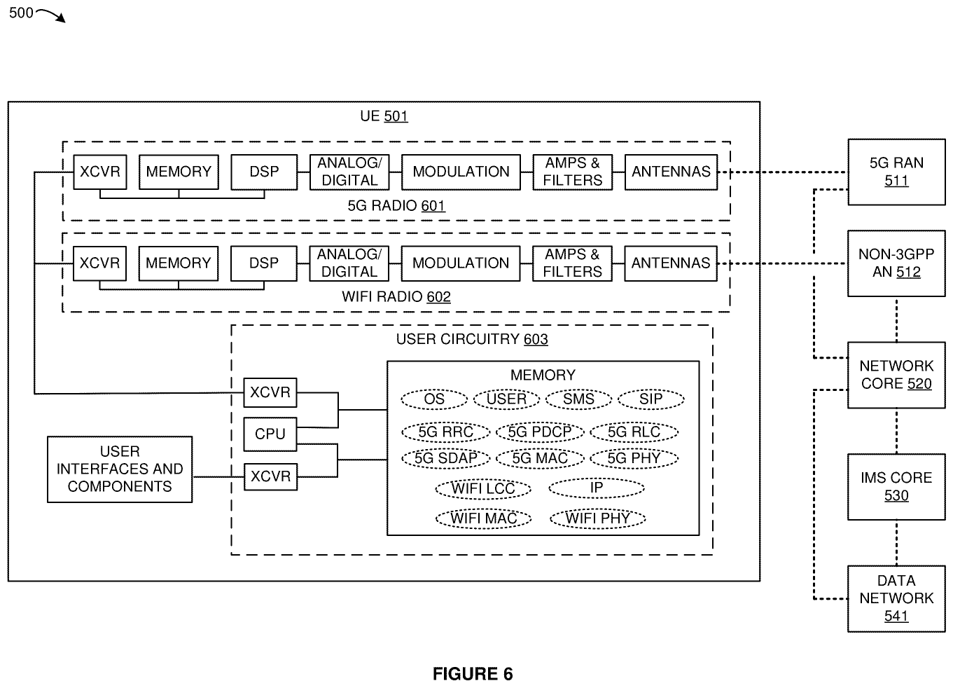

FIG. 6 illustrates UE 501 in 5G communication network 500. UE 501 comprises an example of user device 101, although user device 101 may differ. UE 501 comprises 5G radio 601, Wifi radio 602, and user circuitry 603. 5G Radio 601 comprises 5GNR antennas, amplifiers, filters, modulation, analog-to-digital interfaces, Digital Signal Processers (DSP), memory, and transceivers (XCVRs) that are coupled over bus circuitry. User circuitry 603 comprises memory, CPU, user interfaces and components, and transceivers that are coupled over bus circuitry. Wifi Radio 602 comprises LTE antennas, amplifiers, filters, modulation, analog-to-digital interfaces, Digital Signal Processers (DSP), memory, and transceivers (XCVRs) that are coupled over bus circuitry. User circuitry 603 comprises memory, CPU, user interfaces and components, and transceivers that are coupled over bus circuitry.

The memory in user circuitry 603 stores an operating system (OS), user applications, Short Message Service (SMS) applications, Session Initiation Protocol (SIP) applications, 5GNR network applications for PHY, MAC, RLC, PDCP, SDAP, and RRC, and Wifi network applications for PHY, MAC, and Logical Link Control (LLC). The antenna in 5G radio 601 is wirelessly coupled to 5G RAN 511 over a 5GNR link. The antenna in Wifi radio 602 is wirelessly coupled to non-3GPP access node 512. Transceivers in radios 601 and 602 are coupled to a transceiver in user circuitry 603. A transceiver in user circuitry 603 is typically coupled to the user interfaces and components like displays, controllers, and memory.

In 5G radio 601, the antennas receive wireless signals from 5G RAN 511 that transport downlink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequency. The analog/digital interfaces convert the demodulated analog signals into digital signals for the DSPs. The DSPs transfer corresponding 5GNR symbols to user circuitry 603 over the transceivers. In user circuitry 603, the CPU executes the network applications to process the 5GNR symbols and recover the downlink 5GNR signaling and data. The 5GNR network applications receive new uplink signaling and data from the user applications. The network applications process the uplink user signaling and the downlink 5GNR signaling to generate new downlink user signaling and new uplink 5GNR signaling. The network applications transfer the new downlink user signaling and data to the user applications. The 5GNR network applications process the new uplink 5GNR signaling and user data to generate corresponding uplink 5GNR symbols that carry the uplink 5GNR signaling and data.

In 5G radio 601, the DSP processes the uplink 5GNR symbols to generate corresponding digital signals for the analog-to-digital interfaces. The analog-to-digital interfaces convert the digital uplink signals into analog uplink signals for modulation. Modulation up-converts the uplink analog signals to their carrier frequency. The amplifiers boost the modulated uplink signals for the filters which attenuate unwanted out-of-band energy. The filters transfer the filtered uplink signals through duplexers to the antennas. The electrical uplink signals drive the antennas to emit corresponding wireless 5GNR signals to 5G RAN 511 that transport the uplink 5GNR signaling and data.

The antennas in WIFI radio 601 are wirelessly coupled to non-3GGP access node 512 over non-3GPP wireless links. Transceivers in WIFI radio 601 are coupled to transceivers in user circuitry 603. The CPU in user circuitry 603 executes the operating system and non-3GPP network applications to exchange data and authentication signaling with non-3GPP access node 512 over Wifi radio 601.

SMS application capabilities comprise SMS over NAS messaging support during default bearer failure. SIP application capabilities comprise SIP message generation. RRC functions comprise authentication, security, handover control, status reporting, QoS, network broadcasts and pages, and network selection. SDAP functions comprise QoS marking and flow control. PDCP functions comprise security ciphering, header compression and decompression, sequence numbering and re-sequencing, de-duplication. RLC functions comprise Automatic Repeat Request (ARQ), sequence numbering and resequencing, segmentation and resegmentation. MAC functions comprise buffer status, power control, channel quality, Hybrid ARQ (HARQ), user identification, random access, user scheduling, and QoS. PHY functions comprise packet formation/deformation, windowing/de-windowing, guard-insertion/guard-deletion, parsing/de-parsing, control insertion/removal, interleaving/de-interleaving, Forward Error Correction (FEC) encoding/decoding, channel coding/decoding, channel estimation/equalization, and rate matching/de-matching, scrambling/descrambling, modulation mapping/de-mapping, layer mapping/de-mapping, precoding, Resource Element (RE) mapping/de-mapping, Fast Fourier Transforms (FFTs)/Inverse FFTs (IFFTs), and Discrete Fourier Transforms (DFTs)/Inverse DFTs (IDFTs). IP application capabilities comprise non-3GPP IP message generation. LLC functions comprise synchronization, multiplexing, flow control, and error-checking. The Wifi MAC and PHY comprise similar functionality to the 5GNR MAC and PHY.

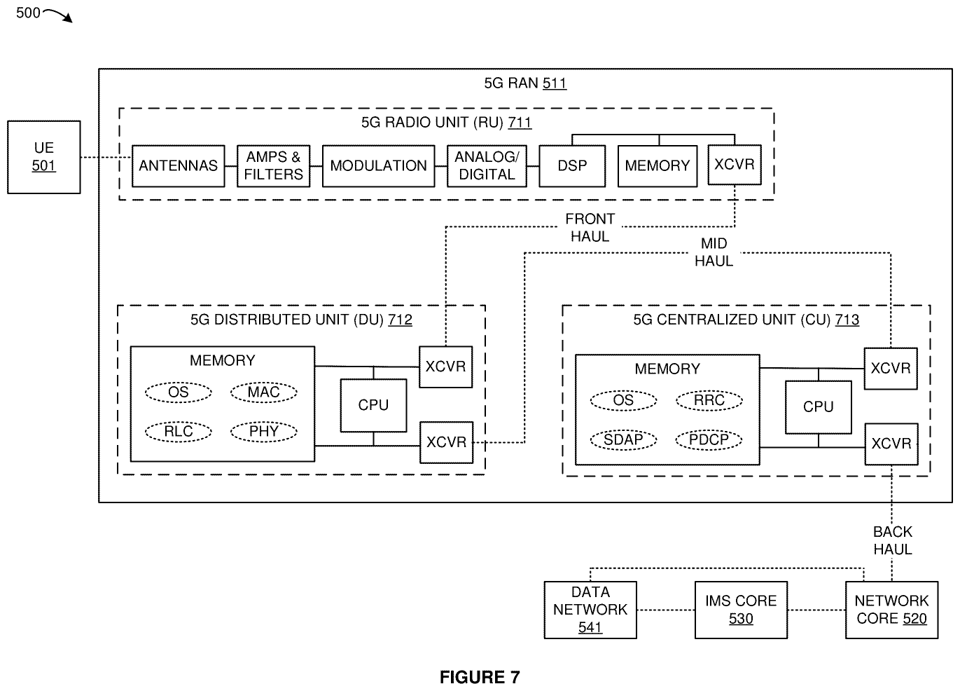

FIG. 7 illustrates 5G RAN 511 in 5G communication network 500. 5G RAN 511 comprises an example of the access network 111 illustrated in FIG. 1, although access network 111 may differ. 5G RAN 511 comprises 5G RU 711, 5G DU 712, and 5G CU 713. RU 711 comprises antennas, amplifiers, filters, modulation, analog-to-digital interfaces, DSP, memory, and transceivers (XCVRs) that are coupled over bus circuitry. UE 501 and 5G/LTE UE 501 are wirelessly coupled to the antennas in RU 711 over 5GNR links. Transceivers in 5G RU 711 are coupled to transceivers in 5G DU 712 over fronthaul links like enhanced Common Public Radio Interface (eCPRI). The DSPs in RU 711 executes their operating systems and radio applications to exchange 5GNR signals with UE 501 and 5G/LTE UE 501 and to exchange 5GNR data with DU 712.

For the uplink, the antennas receive wireless signals from UEs 501 and 502 that transport uplink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequencies. The analog/digital interfaces convert the demodulated analog signals into digital signals for the DSPs. The DSPs transfer corresponding 5GNR symbols to DU 712 over the transceivers.

For the downlink, the DSPs receive downlink 5GNR symbols from DU 712. The DSPs process the downlink 5GNR symbols to generate corresponding digital signals for the analog-to-digital interfaces. The analog-to-digital interfaces convert the digital signals into analog signals for modulation. Modulation up-converts the analog signals to their carrier frequencies. The amplifiers boost the modulated signals for the filters which attenuate unwanted out-of-band energy. The filters transfer the filtered electrical signals through duplexers to the antennas. The filtered electrical signals drive the antennas to emit corresponding wireless signals to UEs 501 and 502 that transport the downlink 5GNR signaling and data.

DU 712 comprises memory, CPU, and transceivers that are coupled over bus circuitry. The memory in 5G DU 712 stores operating systems and 5GNR network applications like PHY, MAC, and RLC. CU 713 comprises memory, CPU, and transceivers that are coupled over bus circuitry. The memory in CU 713 stores an operating system and 5GNR network applications like PDCP, SDAP, and RRC. Transceivers in 5G DU 712 are coupled to transceivers in RU 711 over front-haul links. Transceivers in DU 712 are coupled to transceivers in CU 713 over mid-haul links. A transceiver in CU 713 is coupled to network core 520 over backhaul links.

RLC functions comprise ARQ, sequence numbering and resequencing, segmentation and resegmentation. MAC functions comprise buffer status, power control, channel quality, HARQ, user identification, random access, user scheduling, and QoS. PHY functions comprise packet formation/deformation, guard-insertion/guard-deletion, parsing/de-parsing, control insertion/removal, interleaving/de-interleaving, FEC encoding/decoding, channel coding/decoding, channel estimation/equalization, and rate matching/de-matching, scrambling/descrambling, modulation mapping/de-mapping, layer mapping/de-mapping, precoding, RE mapping/de-mapping, FFTs/IFFTs, and DFTs/IDFTs. PDCP functions include security ciphering, header compression and decompression, sequence numbering and re-sequencing, de-duplication. SDAP functions include QoS marking and flow control. RRC functions include authentication, security, handover control, status reporting, QoS, network broadcasts and pages, and network selection.

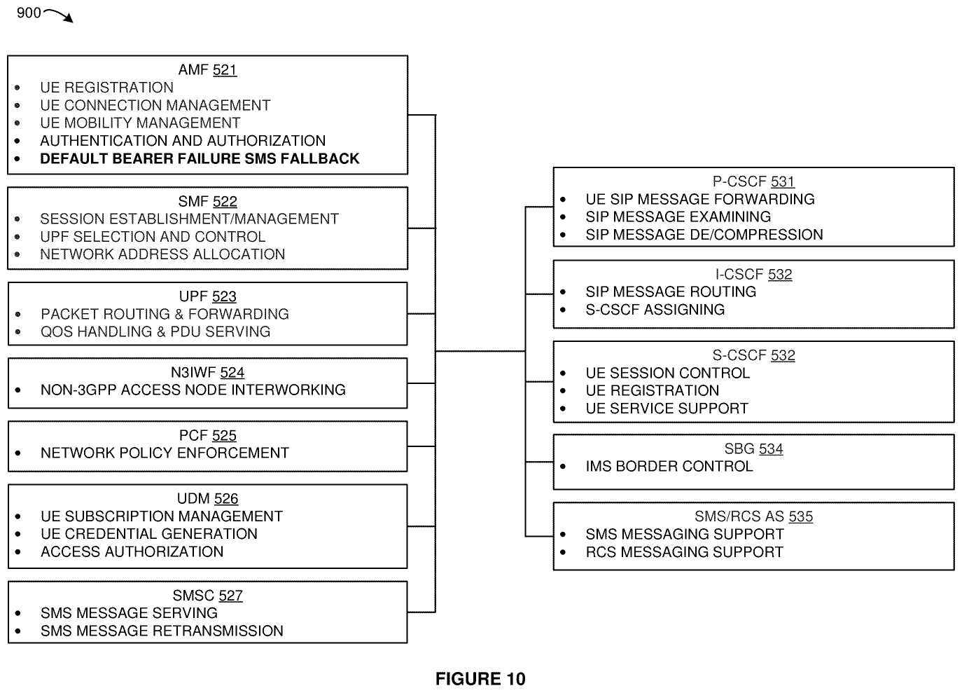

FIG. 10 illustrates non-3GPP access node 512 in 5G communication network 500. Non-3GPP access node 512 comprises an example of the access network 111, although access network 111 may differ. Non-3GPP access node 512 comprises WIFI radio 801 and node circuitry 802. Non-3GPP access node 512 may comprise a trusted access node or an untrusted access node. WIFI radio 801 comprises antennas, amplifiers, filters, modulation, analog-to-digital interfaces, DSP, memory, and transceivers that are coupled over bus circuitry. Node circuitry 802 comprises memory, CPU, and transceivers that are coupled over bus circuitry. The memory in node circuitry 802 stores operating systems and network applications like WIFI PHY, WIFI MAC, WIFI LLC, IP, and 3GPP Networking (NET). Other wireless protocols like bluetooth and narrowband internet-of-things could be used.

The antennas in WIFI radio 801 are wirelessly coupled to UE 501 over non-3GPP wireless links. Transceivers in WIFI radio 801 are coupled to transceivers in node circuitry 3002. Transceivers in node circuitry 802 are coupled to transceivers in N3IWF 534 over backhaul links. The CPU in node circuitry 802 executes the operating system and network applications to exchange data and authentication signaling with UE 501.

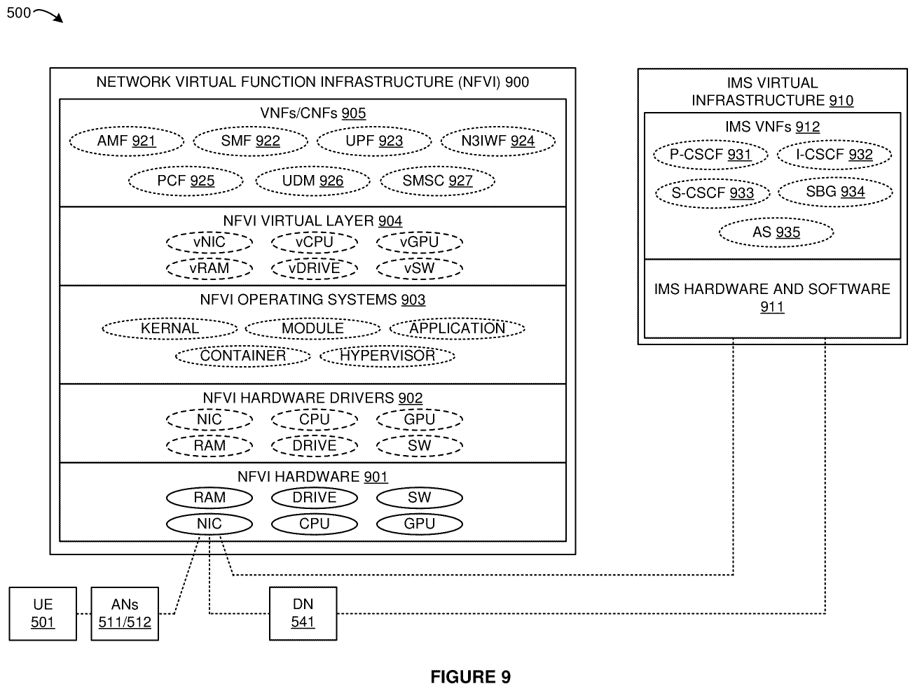

FIG. 9 illustrates Network Function Virtualization Infrastructure (NFVI) 900 and IMS virtual infrastructure 901 in 5G wireless communication network 500. NFVI 900 comprises an example of core network 120 illustrated in FIG. 1, although core network 120 may differ. NFVI 900 comprises NFVI hardware 901, NFVI hardware drivers 902, NFVI operating systems 903, NFVI virtual layer 904, and NFVI Virtual Network Functions (VNFs)/Cloud-Native Network Functions (CNFs) 905. NFVI hardware 901 comprises Network Interface Cards (NICs), CPU, GPU, RAM, Flash/Disk Drives (DRIVE), and Data Switches (SW). NFVI hardware drivers 902 comprise software that is resident in the NIC, CPU, GPU, RAM, DRIVE, and SW. NFVI operating systems 903 comprise kernels, modules, applications, containers, hypervisors, and the like. NFVI virtual layer 904 comprises vNIC, vCPU, vGPU, vRAM, vDRIVE, and vSW. NFVI VNFs/CNFs 905 comprise AMF 921, SMF 922, UPF 923, N3IWF 924, PCF 925, UDM 926, and SMSC 927. Additional VNFs and network elements like AUSF, SMSF, NSSF, NEF, NRF, and AF are typically present but are omitted for clarity.

IMS virtual infrastructure 910 comprises an example of multimedia core 130 illustrated in FIG. 1, although core 130 may differ. IMS virtual infrastructure 910 comprises IMS hardware and software 911 and IMS VNFs 912. IMS hardware and software 911 comprises NICs, CPU, GPU, RAM, DRIVE, and SW and hardware drivers resident in the NIC, CPU, GPU, RAM, DRIVE, and SW. IMS hardware and software 911 comprises operating systems like kernels, modules, applications, containers, and hypervisors as well as a virtual layer that comprises vNIC, vCPU, GPU, vRAM, vDRIVE, and vSW. IMS VNFs comprise P-CSCF 931, I-CSCF 932, S-CSCF 933, SBG 934, and RCS/SMS AS 935. Additional VNFs and network elements like TAS and ISBC are typically present but are omitted for clarity.

NFVI 900 and IMS virtual infrastructure 910 may be co-located, each located at a single site, or be distributed across multiple geographic locations. The NIC in NFVI hardware 901 is coupled to 5G RAN 511, non-3GPP access node 512, the NIC in IMS hardware and software 911, and data network (DN) 541. The NIC in IMS hardware and software 911 is coupled to the NIC in NFVI hardware 901 and to data network 541. NFVI hardware 901 executes NFVI hardware drivers 902, NFVI operating systems 903, NFVI virtual layer 904, and NFVI VNFs/CNFs 905 to form AMF 521, SMF 522, UPF 523, PCF 525, UDM 526, MME 531, S-GW 532, P-GW 533, HSS 534, and SMSC 527. The hardware in IMS hardware and software and software 911 executes the hardware drives, operating systems, virtual layer, and IMS VNFs 912 to form P-CSCF 531, I-CSCF 532, S-CSCF 533, SBG 545, and RCS/SMS AS 535.

FIG. 10 further illustrates NFVI 900 and IMS virtual infrastructure 910 in 5G communication network 500. AMF 521 comprises capabilities for UE registration, UE connection management, UE mobility management, authentication, authorization, and default bearer failure SMS fallback. SMF 522 comprises capabilities for session establishment, session management, UPF selection, UPF control, and network address allocation. UPF 523 comprises capabilities for packet routing, packet forwarding, QoS handling, and PDU serving. PCF 525 comprises capabilities network policy enforcement. UDM 526 comprises capabilities for UE subscription management, UE credential generation, and UE access authorization. SMSC 527 comprises capabilities for SMS message serving and SMS message retransmission. P-CSCF 531 comprises capabilities for UE SIP message forwarding, SIP message examining, and SI message compression/decompression. I-CSCF 532 comprises capabilities for UE session SIP message routing and S-CSCF assigning. S-CSCF 533 comprises capabilities for UE session control, UE registration, and UE service support. SBG 534 comprises capabilities for IMS border control. SMS/RCS 535 comprises capabilities for SMS and RCS messaging support.

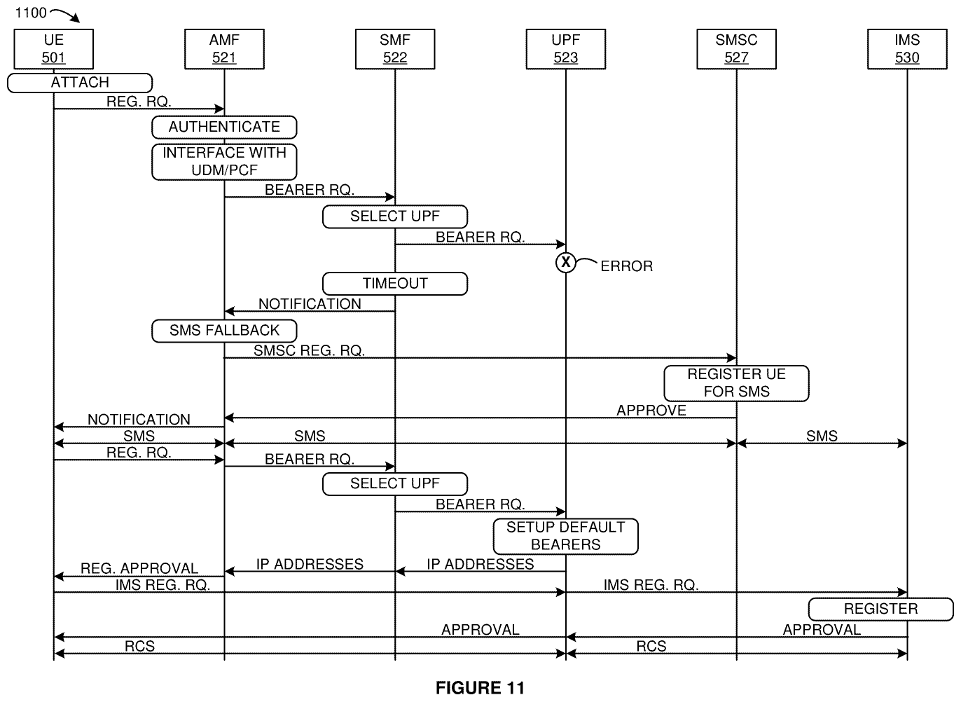

FIG. 11 illustrates process 1100. Process 1100 comprises an exemplary operation of 5G communication network 500 to maintain SMS messaging capability for a wireless user device in response to default bearer setup failure. Process 1100 comprises an example of processes 200, 300, and 400 illustrated in FIGS. 2-4, however processes 200, 300, and 400 may differ. Process 1100 may vary in other examples. In some examples, UE 501 wirelessly attaches to 5G RAN 511. The RRC in UE 501 transfers a registration request to the RRC in 5G RAN 511 over the lower layer radio applications like SDAP, PDCP, RLC, MAC, and PHY. The RRC in 5G RAN 511 forwards the request to AMF 521. In response to the registration request, AMF 521 interfaces with UDM 526 and typically other network functions to authenticate UE 501. Responsive to the authentication, AMF 521 retrieves subscriber data for UE 501 from UDM 526 and generates context using the retrieved data. AMF 521 interfaces with PCF 525 to create a policy association for UE 501.

Responsive to policy association creation, AMF 521 transfers a PDU session list (as received during the registration request) and PDU session activation command to create a default bearer for UE 501. SMF 522 allocates a UE IP addresses for the requested PDU sessions, allocates a TEID, and selects UPF 523 to support the PDU sessions. SMF 522 transfers a session modification request that includes a session endpoint identifier and TEID to UPF 523 to setup the default bearer for UE 501. An error occurs on UPF 523 and the connection times out. SMF 522 notifies AMF 521 of the bearer failure.

To provide a communication link to UE 501 during default bearer failure, AMF 521 transfers an SMS over NAS registration request to SMSC 527 for UE 501. SMSC 527 interfaces with UDM 526 to retrieve an SMS messaging APN for UE 501. SMSC 527 registers UE 501 for SMS over NAS service and indicates the registration and APN to AMF 521. AMF 521 generates a registration failure message that indicates the default bearer creation failure and that SMS over NAS is enabled for UE 501. AMF 521 transfers the message in NAS signaling to the RRC in RAN 511. The RRC delivers the message to the RRC in UE 501 over the lower layer radio applications. The RRC drives the user interface systems in UE 501 to display a notification indicating voice/data service are unavailable and that SMS over NAS is enabled. An SMS application in UE 501 exchanges SMS messages with the RRC in RAN 511 over the lower layer radio applications. The RRC in RAN 511 exchanges the SMS messages with AMF 521. AMF 521 exchanges the SMS messages with SMSC 527 which routes the messages to their destinations over data network 541.

The RRC in UE 501 generates and transfers a retry request in NAS signaling to the RRC in RAN 511 over the lower layer radio applications. The RRC forwards the retry request to AMF 521. To reattempt setting up the default bearer, AMF 521 transfers another PDU session list and PDU session activation command to SMF 522. At this point, the network error on UPF 523 is resolved. SMF 522 allocates UE IP addresses for the requested PDU sessions, allocates a TEID, and selects UPF 523 to support the PDU sessions. SMF 522 transfers a session modification request that includes a session endpoint identifier and TEID to UPF 523 to setup the default bearer for UE 501. UPF 523 acknowledges the request and sets up a default bearer between UE 501, IMS core 530, and data network 541.

SMF 522 notifies AMF 521 that the default bearer is established. In response to bearer establishment, AMF 521 registers UE 501 for service on network 500. AMF 521 generates a registration accept message that includes the UE context, allocated IP addresses for UE 501, and network address for P-CSCF 531. AMF 521 transfers a deregistration message to SMSC 527 to terminate SMS over NAS for UE 501. AMF 521 transfers the registration accept message in NAS signaling to the RRC in RAN 511. The RRC delivers the accept message to the RRC in UE 501 over the lower layer radio applications.

In response to successfully registering on network 500, the RRC in UE 501 drives the SIP application in UE 501 to transfer a SIP registration message to the SDAP in RAN 511 over the lower layer radio applications. The SDAP forwards the request to P-CSCF 631 over UPF 523. P-CSCF 531 interfaces with the other functions in IMS core 530 to register UE 501 for IMS service. P-CSCF 531 indicates the successful IMS registration to the SDAP in RAN 511 over UPF 523. The SDAP delivers the registration message to UE 501 over the lower layer radio applications.

UE 501 initiates an RCS session with another UE over IMS core 530. The SIP application generates a SIP invite message and addresses the message for delivery to P-CSCF 531. The SIP application in UE 501 transfers the SIP invite to P-CSCF 531 over the default bearer that traverses RAN 511, UPF 523, and SBG 534. P-CSCF 531 interfaces with I-CSCF 532 and S-CSCF 533 to deliver the SIP invite to the called UE. The called UE receives and accepts the SIP invite. P-CSCF 531 notifies S-CSCF 533 of the acceptance. S-CSCF 533 interfaces with RCS AS 535 to organize and control the end-to-end RTP connection between UE 501 and the called UE. Once the RTP link is set up, the RCS session may begin. The SDAP in UE 501 exchanges user data for the RCS session with the SDAP in RAN 511 over the lower layer radio application. The SDAP in RAN 611 exchanges the user data with UPF 523. UPF 523 exchanges the data with data network 541. S-CSCF 533 interfaces with one or more of P-CSCF 531, I-CSFC 632, and RCS AS 535 to monitor the RCS session and control the data flow between UE 501 and data network 541.

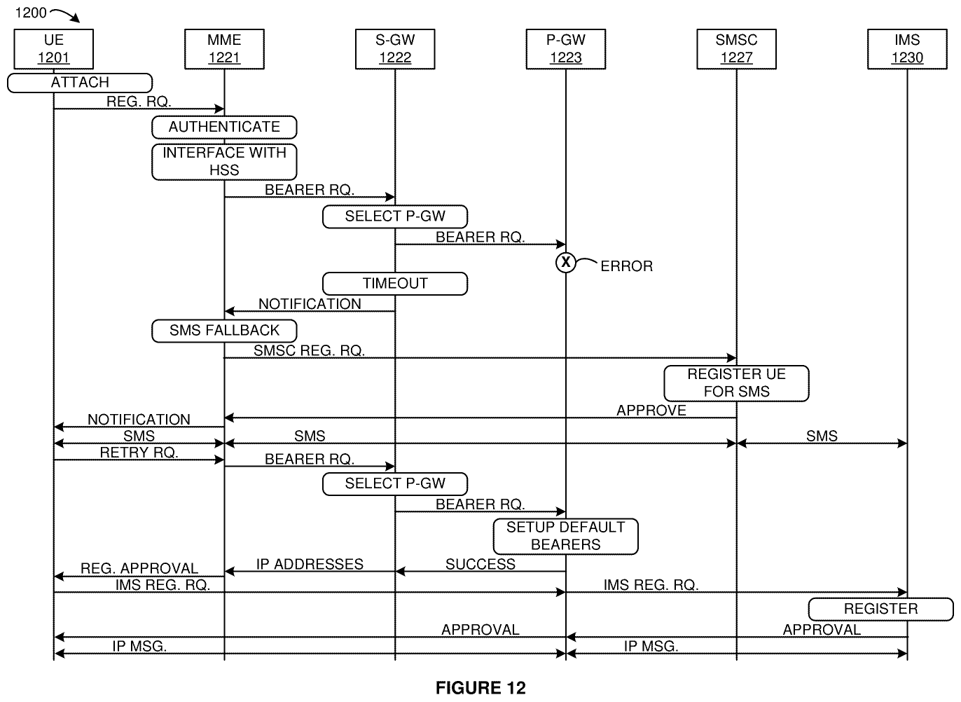

FIG. 12 illustrates LTE communication network 1200. Network 1200 is an example of network 100 illustrated in FIG. 1 and network 500 illustrated in FIG. 5, however networks 100 and 500 may differ. Network 1200 comprises LTE UE 1201, Mobility Management Entity (MME) 1221, Serving Gateway (S-GW) 1222, Packet Gateway (P-GW) 1223, SMSC 1227, and IMS core 1230. UE 1201 attaches to an LTE eNodeB (not illustrated) over an LTE wireless link. UE 1201 transfers a registration request to MME 1221. MME 1221 interacts with other network entities (typically Home Subscriber Server (HSS)), to authenticate and authorize UE 1201 for wireless network service. Responsive to authentication and authorization, MME 1221 transfers a default bearer request to S-GW 1222. S-GW 1222 allocates an IP address for UE 1201 and selects P-GW 1223 to serve UE 1201. S-GW 1222 directs P-GW 1223 to set up the default bearer over eNodeB, however an error occurs in P-GW 1223 and the connection times out. S-GW 1222 notifies MME 1221 of the bearer failure and MME 1221 elects to perform an SMS fallback for UE 1201. MME 1221 transfers a registration request for SMS over NAS service to SMSC 1227. SMSC 1227 registers UE 1201 for SMS over NAS service and indicates the approval to MME 1221. MME 1221 transfers a registration failure message indicating the default bearer failure and that SMS over NAS is enabled. UE 1201 exchanges SMS messages with MME 1221 over a NAS link that traverses the eNodeB. MME 1221 exchanges SMS messages with SMSC 1227. SMSC 1227 routes the SMS messages to message destinations through IMS core 1230.

Based on the registration failure, UE 1201 transfers a retry request to MME 1221 to attempt to establish the default bearer. MME 1221 transfers another default bearer request to S-GW 1222. S-GW 1222 allocates an IP address for UE 1201 and selects P-GW 1223 to serve UE 1201. S-GW 1222 directs P-GW 1223 to set up the default bearer over the eNodeB. At this point, the error in P-GW 1223 is resolved and P-GW 1223 sets up the default bearer for UE 1201 over the eNodeB. S-GW 1222 notifies MME 1221 of the bearer success and indicates the allocated IP address for UE 1201 to MME 1221. MME 1221 interfaces with SMSC 1227 to deregister UE 1201 for SMS over NAS service and transfers a registration approval message to UE 1201.

In response to the successful registration, UE 1201 transfers an IMS registration request over the default bearer to IME core 1230. IMS core 1230 registers UE 1201 for IMS services (e.g., voice calling, video calling, IP messaging) and transfers a registration approval message to UE 1201. UE 1201 begins an IP based session with other UE (not illustrated). UE 1201 exchanges IP packets over the default bearer that traverses the eNodeB with P-GW 1223. P-GW 1223 routes the packets to the message destination over IMS core 1230.

The wireless data network circuitry described above comprises computer hardware and software that form special-purpose network circuitry to maintain communication links for a wireless user device during default bearer failure. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose network circuitry to maintain communication links for a wireless user device during default bearer failure.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A method comprising:
in a control plane of a wireless communication network:
in response to a multimedia bearer failure for a wireless user device, registering the wireless user device for control plane messaging;
exchanging text messages with the user device over a signaling link of the control plane;
in response to establishment of a multimedia bearer for the wireless user device, deregistering the wireless user device for control plane messaging; and
directing the wireless user device to register with a multimedia system for service over the multimedia bearer.

2. The method of claim 1 further comprising:
transferring a multimedia bearer setup request to a session manager associated with the user device; and
receiving an Internet Protocol (IP) address allocation failure notification from the session manager that indicates the multimedia bearer failure.

3. The method of claim 1 further comprising:
transferring a multimedia bearer setup request to a session manager associated with the user device; and
receiving a user plane timeout notification from the session manager that indicates the multimedia bearer failure.

4. The method of claim 1 wherein:
registering the wireless user device for the control plane messaging comprises registering the user device with a Short Message Service Center (SMSC) for Short Message Service (SMS) messaging over Non-Access Stratum (NAS) signaling; and
exchanging the text messages with the user device over the signaling link of the control plane comprises exchanging SMS messages with the user device over a NAS link.

5. The method of claim 1 further comprising transferring a notification to the user device that indicates the multimedia bearer failure and the control plane messaging is enabled.

6. The method of claim 1 further comprising:
receiving a retry request from the wireless user device;
transferring a multimedia bearer setup request to a session manager associated with the user device; and
receiving a bearer setup success notification from the session manager that indicates the establishment of the multimedia bearer.

7. The method of claim 1 wherein deregistering the wireless user device for control plane messaging comprises directing a Short Message Service Center (SMSC) to deregister the user device for Short Message Service (SMS) messaging over Non-Access Stratum (NAS) signaling.

8. The method of claim 1 wherein directing the wireless user device to register with the multimedia system for service over the multimedia bearer comprising transferring a registration approval message that indicates the establishment of the multimedia bearer and that directs the user device to register with the multimedia system.

9. A wireless communication network comprising:
a user plane configured to support a multimedia bearer for a wireless user device; and
a control plane configured to:
in response a multimedia bearer failure for the wireless user device, register the wireless user device for control plane messaging;
exchange text messages with the user device over a signaling link of the control plane;
in response to establishment of the multimedia bearer for the wireless user device, deregister the wireless user device for control plane messaging; and
direct the wireless user device to register with a multimedia system for service over the multimedia bearer.

10. The wireless communication network of claim 9 wherein the control plane is configured to:
transfer a multimedia bearer setup request to a session manager associated with the user device; and
receive an Internet Protocol (IP) address allocation failure notification from the session manager that indicates the multimedia bearer failure.

11. The wireless communication network of claim 9 wherein the control plane is configured to:
transfer a multimedia bearer setup request to a session manager associated with the user device; and
receive a user plane timeout notification from the session manager that indicates the multimedia bearer failure.

12. The wireless communication network of claim 9 wherein the control plane is configured to:
register the wireless user device with a Short Message Service Center (SMSC) for Short Message Service (SMS) messaging over Non-Access Stratum (NAS) signaling; and
exchange SMS messages with the user device over a NAS link.

13. The wireless communication network of claim 9 wherein the control plane is configured to transfer a notification to the user device that indicates the multimedia bearer failure and the control plane messaging is enabled.

14. The wireless communication network of claim 9 wherein the control plane is configured to:
receive a retry request from the wireless user device;
transfer a multimedia bearer setup request to a session manager associated with the user device; and
receive a bearer setup success notification from the session manager that indicates the establishment of the multimedia bearer.

15. The wireless communication network of claim 9 wherein the control plane is configured to direct a Short Message Service Center (SMSC) to deregister the user device for Short Message Service (SMS) messaging over Non-Access Stratum (NAS) signaling.

16. The wireless communication network of claim 9 wherein the control plane is configured to transfer a registration approval message that indicates the establishment of the multimedia bearer and that directs the user device to register with the multimedia system.

17. The wireless communication network of claim 9 further comprising network circuitry configured to execute the user plane and the control plane.

18. One of more non-transitory computer readable storage media having program instructions stored thereon, wherein the program instruction, when executed by a computing system, direct the computing system to perform operations, the operations comprising:
during initial registration, receiving a failure notification that indicates a default bearer setup failure for a wireless user device;
in response to the default bearer setup failure, registering the wireless user device with a Short-Message-Service Center (SMSC);
exchanging Short-Message-Service (SMS) messages for the user device with the SMSC;
exchanging the SMS messages with the user device of a Non-Access Stratum (NAS) link;
subsequent to receiving a retry request from the wireless user device, receiving a success notification that indicates a default bearer setup success for the wireless user device;
in response to the default bearer setup success, deregistering the wireless user device with the SMSC;
notifying the wireless user device of the default bearer setup success; and
directing the wireless user device to use the default bearer for messaging.

19. The computer readable storage media of claim 18 wherein the default bearer setup failure comprises an Internet Protocol (IP) address allocation failure.

20. The computer readable storage media of claim 18 wherein the default bearer setup failure comprises a User Plane Function (UPF) timeout.
